(19) United States
(12) Patent Application Publication
(10) Pub. No.: US 2016/0252673 A1
(43) Pub. Date: Sep. 1, 2016

(54) Polarization Maintaining Single-Mode Low-Loss Hollow-Core Fiber

(71) Applicant: OFS Fitel, LLC, Norcross, GA (US)

(72) Inventors: John M Fini, San Jose, CA (US); Jeffrey W Nicholson, Warren, NJ (US); Robert Windeler, Annandale, NJ (US); Eric M Monberg, Princeton, NJ (US); Anthony Desantolo, North Plainfield, NJ (US); Frank V DiMarcello, Annandale, NJ (US)

(21) Appl. No.: 14/599,666

(22) Filed: Jan. 19, 2015

Related U.S. Application Data
(60) Provisional application No. 61/930,673, filed on Jan. 23, 2014.

(51) Int. Cl. G02B 6/024; G02B 6/02

(52) U.S. Cl. CPC G02B 6/024; G02B 6/02328; G02B 6/02347; G02B 6/02042

(57) ABSTRACT

A hollow core fiber exhibiting selective birefringence is provided. The selective birefringence is induced by harnessing properties of surface modes that cause transmission loss and are otherwise considered as detrimental. Birefringence and signal loss in a preferred polarization state are engineered by fabricating an asymmetrical web structure surrounding the core. In one implementation the asymmetry in the web structure is induced by a thicker core web preferably at the core inner cladding interface, by selectively introducing defect cells at the hollow core inner cladding interface. The hollow core fiber further includes shunt cores to facilitate near single-mode transmission by additionally using intermittent bend-induced index matching to resonantly couple unwanted core modes including one or more, higher order modes to shunt modes. In another aspect of the invention asymmetrical web structure is applied to induce controlled birefringence in a PRISM fiber to achieve near single-moded, single-polarization state transmission.

### CROSS REFERENCE TO RELATED APPLICATIONS

The present application seeks priority benefit from the U.S. Provisional Application No. 61/930,673 filed on Jan. 23, 2014 by Fini et al., and is being filed as a Continuation In Part (CIP) of the PCT application No. PCT/US/1332652 filed in the United States Receiving Office on Mar. 15, 2013 by DiGiovanni et al., and a Continuation In Part (CIP) of the PCT application No. PCT/US/1335345 filed in the United States Receiving Office on Apr. 4, 2013 by Fini et al.; the contents of the above referenced applications co-owned by the assignee of the present application, is being incorporated by reference herein in their entirety.

### STATEMENT REGARDING FEDERALLY SPONSORED RESEARCH AND DEVELOPMENT

This invention reported in this application is supported using a government grant awarded by DARPA under the contract No. HR0011-08-C-0019. The government has certain rights in the invention.

### BACKGROUND OF THE INVENTION

1. Field of the Invention

This application is related to the field of optical fiber and in particular, to Hollow Core Fiber (HCF) for near single mode transmission of a signal in a preferred single polarization state in the hollow core of the fiber.

2. Description of the Related Arts

Hollow core fiber is a powerful technology platform offering breakthrough performance improvements in sensing, communications, higher-power optical pulse delivery, and other applications. Free from the usual constraints of what materials are suitable to guide light, HCF promises qualitatively new and ideal operating regimes: precision signals transmitted free of nonlinearities, sensors that guide light directly in the samples they are meant to probe, etc. However, these fibers have not been widely adopted, largely because uncontrolled coupling between transverse and polarization modes overshadows their benefits. To deliver on their promises, hollow-core fibers must retain their unique properties while achieving the modal and polarization control that are essential for their most compelling applications.

A HCF comprises a core surrounded by a cellular matrix structure of holes (voids) in an interconnected web (web or a mesh, hereinafter) of silica glass. Individual cells (matrix cells) in the web are distributed in a regular periodic arrangement (in three dimension physical space) with a uniform nominal spacing between the holes (substantially similar to a lattice spacing in a crystal). The core is a region devoid of the cellular matrix structure and therefore is termed ‘hollow’ core. The cellular matrix also referred as an inner cladding, is analogous to the cladding of a solid glass fiber. The light in the hollow core is guided by the photonic bandgap exhibited by the periodic structure of the cellular matrix outside the hollow core. Often, the inner cladding is surrounded by another cladding region typically known as the outer cladding.

Bandgap guided fibers radically changed the rules of what kinds of materials could guide light. Most dramatically, bandgap-guided hollow-core fibers (HCF) can guide light in materials like air or water, even though their refractive index is lower than any available solid cladding material. The unique, qualitative advantages of hollow-core fibers seem perfectly suited to many applications. For example, they can provide ultra-low nonlinearity since most of the signal power can be guided in air or vacuum thereby removing a key fundamental limit on signal to noise ratio in data transmission and precision measurement. Guidance in a hollow core also mitigates other impairments related to interaction of the signal with the substrate, for example, thermal drift of propagation parameters. In sensing of gas and liquid samples where fiber nonlinearities contribute significantly to noise and hence compromise performance, low-loss guidance directly in the sample provides ideal sensitivity. In delivery of high power pulses, guidance in air avoids damage of the core material. In low-latency transmission, guidance in air provides the guaranteed lowest time-of-flight delay possible.

In prior-art HCF, there is a known tradeoff between loss and single mode operation. One source of loss is scattering from naturally occurring surface roughness at core-inner cladding interfaces. While fabrication methods can impact surface roughness, they cannot reduce it below a thermodynamic limit. The ultimate limit to attenuation in HCF is currently thought to be determined by the surface roughness due to frozen in capillary waves. The lowest loss in currently available HCF is already at, or near this limit. Further reduction of loss has proven difficult to attain by further straightforward improvements in fabrication process alone. One way to further reduce the loss is, to increase the core size, and thus decrease the interaction of light with the surface. While calculations indicate that this trend can be continued, in reality as the core size increases the fiber tends to support a few more higher order modes (HOM) because these HOMs may have loss that is comparable to that of the fundamental mode (for convenience will be referred as multi-mode or few-moded HCF hereinafter).

Unwanted and unavoidable persistent modes could be a significant source of impairments (such as, Multi-Photon Interference (MPI), mode-coupling loss, etc.). U.S. Pat. No. 7,356,233 issued on Apr. 8, 2008, to Fini, describes a method to mitigate optical losses and other impairments due to unwanted modes. The contents of the above mentioned patent co-owned by the Assignee of this application, is being incorporated by reference in its entirety. More specifically, the inner cladding selectively incorporates design features intended to alter the behavior of unwanted modes, for example, by incorporating an additional hollow core having a smaller diameter placed within the inner cladding region, but at some distance away from the central core.

The additional hollow waveguide according to the above mentioned co-owned patent referred as a ‘shunt core’, may be placed anywhere within the inner cladding region between the central hollow core and the outer cladding region, preferably near the outer cladding. The additional core provides a disruption, or a perturbation, in the periodicity of the inner cladding lattice structure and supports cladding modes (also referred as shunt modes). By properly designing and constructing these perturbation regions, higher order modes of the central core may be resonantly coupled to one or more shunt modes. As a result, higher order modes are selectively dissipated rapidly due to high loss in the shunt modes.

A different approach to achieve near single mode operation of a HCF is described in the co-owned and co-pending PCT Application No. PCT/US/1335345 filed in the United States Receiving Office on Apr. 4, 2013, also by Fini et al. The contents of the above mentioned PCT application co-owned by the Assignee of this application, is being incorporated by reference in its entirety. In this method statistical modeling combined with a step index fiber model allows very precise determination of design parameters for HCF for example, lattice spacing of the inner cladding layer, core and shunt sizes, shape, separation and dilation in core size, to generate a small known amount of effective index mismatch between an unwanted core mode and a shunt mode such that the effective index mismatch is compensated together with a bend induced shift in effective index so as to ensure that an unwanted mode is efficiently coupled to one or more shunt modes somewhere along the length of the fiber.

One advantage of the approach described in the above identified co-pending PCT application is that resonant phase matching occurs along the length of the fiber. According to one aspect of the invention, resonant phase matching over a substantial portion of the length of the fiber is sufficient to suppress unwanted modes effectively. The HCF functions as a PRISM (Perturbed Resonance for Improved Single Modedness) fiber that would remove the light in the unwanted modes by coupling to one or more shunt modes that are designed to have higher loss. The HCF fiber designed following this approach is claimed to effectively function as a near single mode fiber (SMF). Advantageously, resonant phase matching may occur despite the presence of surface modes arising at the boundary of the core and inner cladding. Accordingly, limits on design and manufacturing may be relaxed without compromising the mode suppression mechanism according to this invention. Furthermore, combining the two different modeling approaches allows very precise determination of parameters such that effective index mismatch is made small enough to be compensated with bend induced shift in effective index mismatch that would not require unrealistic conditions on packaging and other physical layout constraints so as to render the fiber inoperable.

Despite showing promise in many exciting laboratory demonstrations, HCF so far has not been widely adopted for many practical applications. This is largely because prior art commercial HCF is primarily multi-moded or at best few-moded. In addition, most HCF exhibit an awkward combination of poor polarization holding combined with high polarization mode dispersion. Poor modal and polarization control make it difficult to fully utilize the benefits of HCF. For example, ultra-low nonlinearity is a clear advantage in applications requiring very precise interferometric sensing, but in these applications noise arising from polarization drift and coupling between transverse modes could easily degrade precision, and outweigh the benefit of low nonlinearity.

Two polarization components of the signal typically present in a guided mode can obscure measurements in a sensor, and generally introduce uncertainty and interference into a system causing additional impairments. A hollow-core fiber having a predominantly single polarization state is desirable for applications such as optical communication where polarization dependent loss may add to other impairments for example, chromatic dispersion. One way to achieve a single polarization state is to selectively suppress one of the two polarization states. In prior art fibers, a variety of features have been proposed to control birefringence. These include modification of surface modes, selective coupling between the core and one or more modes of additional waveguide structures, for example.

Referring back to the co-owned U.S. Pat. No. 7,865,051 issued on Jan. 4, 2011, to Fini, the additional shunt waveguide is designed to support modes which have propagation constants similar to certain undesirable modes of the hollow core (for example, specific HOMs). More specifically, the dimension and geometry of the shunt waveguide is carefully selected such that the core modes having polarization along one axis are selectively coupled to the modes of the shunt waveguide. In the U.S. Pat. No. 7,551,819 issued to Dangui et al. on Jun. 23, 2009, selective suppression of polarization along one axis is utilized in constructing polarization couplers/splitters using hollow core fiber.

A different approach is described in a co-owned and co-pending PCT application No. PCT/US/1332652, filed on Mar. 15, 2013, by DiGiovanni et al., the contents of the above mentioned PCT application co-owned by the Assignee of this application, is being incorporated by reference in its entirety. In the approach described in the above mentioned PCT application, a plurality of defect cells that are different from the matrix cells of the inner cladding region of a hollow core fiber are positioned at or near the hollow core-cladding boundary. The defect cells having at least one property different from the matrix cells are arranged in a pattern that defines two orthogonal axes of reflection symmetry so as to produce birefringence in the hollow core of the fiber. It is particularly noted that the birefringence may be controlled more effectively when the defect cells are positioned proximal to the hollow core-cladding boundary.

A common understanding in controlling polarization states has been that features introduced intentionally in the cellular matrix more than a few lattice periods away from the core, exert little influence or control on mode properties, aside from a tendency of an irregular lattice to cause excess signal loss. Thus, a large volume of prior art suggests that the outer portion of the cladding should contain no useful features intentionally introduced to control birefringence, and in fact should be made as periodic as possible. While many hollow core fibers support polarization suppression to some extent, what is required for best system performance is often a combination of properties difficult to achieve simultaneously namely, single mode transmission in the hollow core, low loss in a desired polarization state, high loss in the unwanted polarization state, large resistance to polarization coupling, operation covering a desired band of wavelengths, and robustness to variations in fabrication, just to name a few.

There is a fundamental difficulty in achieving modal or polarization control in a low-loss HCF. Scattering losses are minimized by increasing the core size and reducing the interaction of light with the surface of glass webs surrounding the core. But a large core typically means that unwanted modes are well guided—making the fiber less single-moded. Further, light that does not interact with the glass tends not to see any intentional asymmetry—making it difficult to achieve substantial birefringence with losses less than around 10 dB/km. Introducing stress in the core (a widely used method of making conventional, solid polarization-maintaining (PM) fibers) is clearly not possible in a HCF. In prior art fiber designs all these properties could not be achieved simultaneously.

### SUMMARY OF THE INVENTION

This invention provides a new hollow core fiber (HCF) exhibiting effective single mode transmission in a single polarization state. The new fiber comprises a hollow core surrounded by an inner cladding of a cellular matrix structure of holes (voids) in an interconnected web (web or a mesh, hereinafter) of silica glass. Individual cells (matrix cells) in the web are nominally distributed in a regular periodic arrangement (in two-dimension physical space cross-section perpendicular to the axis of the fiber) with a uniform nominal spacing between the holes. The hollow core is defined as a contiguous region devoid of the matrix cells.

In one aspect of the invention the new HCF achieves near single mode transmission in the hollow core by incorporating one or more additional hollow waveguides or ‘shunts’ in the cladding, so that unwanted core modes are coupled to the shunt modes and stripped away from the hollow core. In another aspect of the invention the unwanted modes are selected higher order core modes. In a variant form a novel coupling scheme utilizing Perturbed Resonance for Improved Single-Modedness (PRISM) may preferably be applied to further facilitate single-mode transmission. More specifically, a fiber implementing PRISM utilizes bend-induced perturbations to make the resonance condition immune to fabrication imperfections, thus allowing robust single-modedness despite the intrinsic sensitivity of hollow-core fibers towards fabrication imperfections, packaging and other physical layout constraints such as bend radius.

In another aspect, birefringence and polarization dependent loss in the new fiber is implemented using an asymmetric web structure for the inner cladding proximal to the hollow core. The asymmetry, microscopic in nature, may be introduced while stacking of the capillaries during the fiber drawing process. In one implementation the asymmetry resulting in birefringence may be introduced by a plurality of cells that are different from the matrix cells of the inner cladding region of a hollow core fiber and are positioned at or near the hollow core-cladding boundary. In one embodiment the plurality of cells are different from the matrix cells in wall thickness of the silica web that connects the cells at the cell walls.

Furthermore, polarization suppression may be controlled by carefully selecting physical properties of the defect cells such as their shape, size, wall thickness, number, position, distance from the hollow core-cladding interface, etc. as well as chemical properties of the material that comprise the defect cells for example, composition of the glass. By selecting these properties either alone or in certain prescribed combinations, a pre-determined mode and/or amount of polarization may be suppressed for a signal transmitted in the hollow core of the fiber.

### BRIEF DESCRIPTION OF THE DRAWINGS

The principle of achieving near single mode and selective polarization transmission in the new fiber will be described in detail in the specification by measured data, optical field profiles as well as simulations. Each aspect described will be illustrated using one or more measured or simulated features that may be used alone or in different combinations with other features shown in other illustrations to fully understand the basic principles. These principles may be better understood in view of attached drawing figures in which:

FIG. 1 shows a schematic representation of a conventional shunt core fiber;

FIG. 2 shows (a) a Scanning Electron Microscope image of a hollow core fiber designed and constructed according to this invention, (b) measured polarization dependent loss, and (c) measured phase birefringence and group birefringence of the fiber;

FIG. 3 shows (a) a schematic of hollow core fiber having roughly analogous structure as the real fiber shown in FIG. 1(a) used for simulation to illustrate surface mode coupling mechanism, (b) a surface mode crossing at 1540 nm causes large polarization dependent scattering, and (c) characteristic anti-crossing behavior for the coupled polarization;

FIG. 4 shows (a) measured polarization beating between two polarization states typically observed for a birefringent fiber), (b) sliding window Fourier transform components, and (c) extinction ratio measured after 467 m of fiber;

FIG. 5 shows calculated mode field images with thick webs introduced to control polarization (a) along a shunt axis and (b) across a shunt axis, respectively; and

FIG. 6 shows calculated mode field images with thick webs introduced to control polarization along a shunt axis at (a) 1530 nm, (c) 1535 nm, (e) 1563 nm, and across a shunt axis at (b) 1530 nm, (d) 1535 nm and (f) 1563 nm, respectively;

FIG. 7 illustrates a basic implementation of a PRISM fiber—(a) physical arrangement resulting in intermittent resonance coupling of unwanted core modes to shunt modes, and differential group delay in a (b) straight section, and (c) coiled section, respectively, of a HCF; and

FIG. 8 shows, (a) bend-induced HOM suppression, and (b) bend-induced perturbation in effective index, and

FIG. 9 shows representative arrangements of capillaries in a stack to construct a polarization maintaining near single mode fiber having (a) two shunts and (b) six shunts, respectively.

### DETAILED DESCRIPTION OF THE INVENTION

Different aspects of the invention will be described using measured data obtained from an actual hollow core fiber constructed according to this invention, as well as simulations performed on a model hollow core fiber that closely resembles the actual fiber constructed according to the principles of the invention illustrated in different drawing figures. For clarity, each drawing figure may include one or more features to highlight a particular aspect of the invention. However, features not shown in a particular drawing figure are not necessarily precluded from that or other embodiments. Accordingly, different features explained using different drawing figures may be used either alone or in combination with other features shown in other embodiments to fully understand the invention.

The HCF according to this invention incorporates two different functionalities namely, single mode operation and polarization control, simultaneously. It may be recalled that the conventional understanding in the art is, that there exists a fundamental tradeoff between polarization control in low-loss HCF and single mode operation (please see the disclosure of the parent applications (co-pending PCT Application No. PCT/US/1335345 filed in the United States Receiving Office on Apr. 4, 2013 by Fini et al, PCT application No. PCT/US/1332652, filed on Mar. 15, 2013, by DiGiovanni et al. and the co-owned U.S. Pat. No. 7,865,051 issued on Jan. 4, 2011, to Fini). The novel design principles incorporate birefringence control by introducing precise amount of asymmetry in an inner cladding layer of a PRISM fiber that also supports low-loss near single mode transmission. The principles will be described using specific results from an experimental set up, however data presented from these results are only exemplary and should not be construed to be limitations.

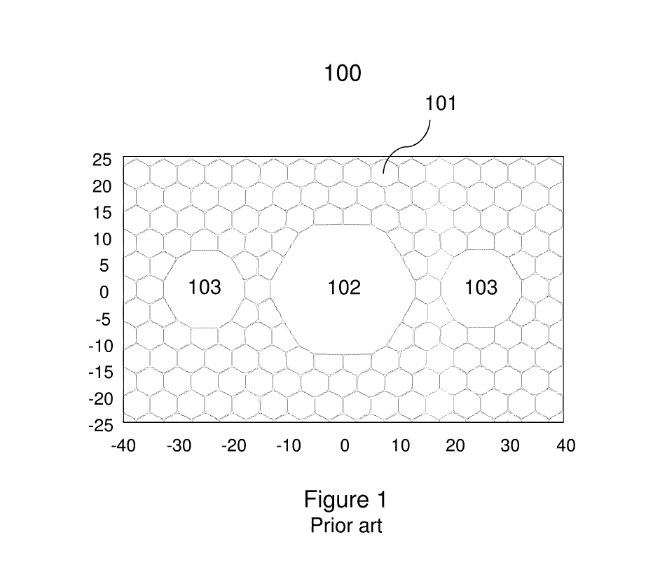

Referring now to FIG. 1, there it shows a schematic of a basic shunt core fiber 100 that represents a framework of the PRISM fiber as described in the co-pending PCT application No. PCT/US/1335345 filed in the United States Receiving Office on Apr. 4, 2013 by Fini et al., and also the basic structure of the HCF designed according to this invention to be described shortly. More specifically, the basic structure of a HCF shown in FIG. 1 has a cellular matrix structure of holes (voids) 101 in an interconnected web (web or a mesh, hereinafter) of silica glass. Individual cells (matrix cells) in the web connect with neighboring cells at the cell walls (boundaries) that in general have uniform nominal thickness throughout the web (uniform web). In the prior art HCF, the cells are distributed in a regular periodic arrangement (in two dimension physical space cross-section perpendicular to the axis of the fiber) with a uniform nominal spacing between the holes (substantially similar to a lattice spacing in a crystal). The cellular lattice has a regular pattern of cells that may approximate a triangular lattice, rectangular lattice, honeycomb lattice, or other well-known lattice patterns.

A central contiguous region 102 devoid of the cellular matrix structure defines a hollow core (or core). The core extends along the length of the fiber. The size of the hollow core is determined by the number of cells (for example a 19-cell or a 7-cell core, etc.) that are contiguously missing in the core region. Specific geometry of the core (for example, elliptical, oblong, circular or hexagonal core shape) may be determined according to the required polarization and transmission properties desired for a particular application. The shape and size of the core shown and described in the specification are just exemplary and should not be construed to be limitations. The light to be transmitted in the hollow core is confined and guided in the hollow core by the photonic bandgap resulting from the periodic structure of the cellular matrix outside the hollow core (a concept similar to electronic band gap in a semiconductor crystal).

The cellular matrix functions as a cladding (often referred as inner cladding) analogous to a cladding of a solid core glass fiber. The inner cladding is typically surrounded by a second cladding region known as the outer cladding. Besides the core, additional one or more hollow regions 103 are included in a PRISM fiber along the length of the fiber. The additional one or more hollow region is in general smaller in size as compared to the core and often referred as shunt core(s) in this context. The number of shunt cores is not limited to two as shown in this example, and may be positioned symmetrically or non-symmetrically around the core depending upon the application.

### Polarization Control

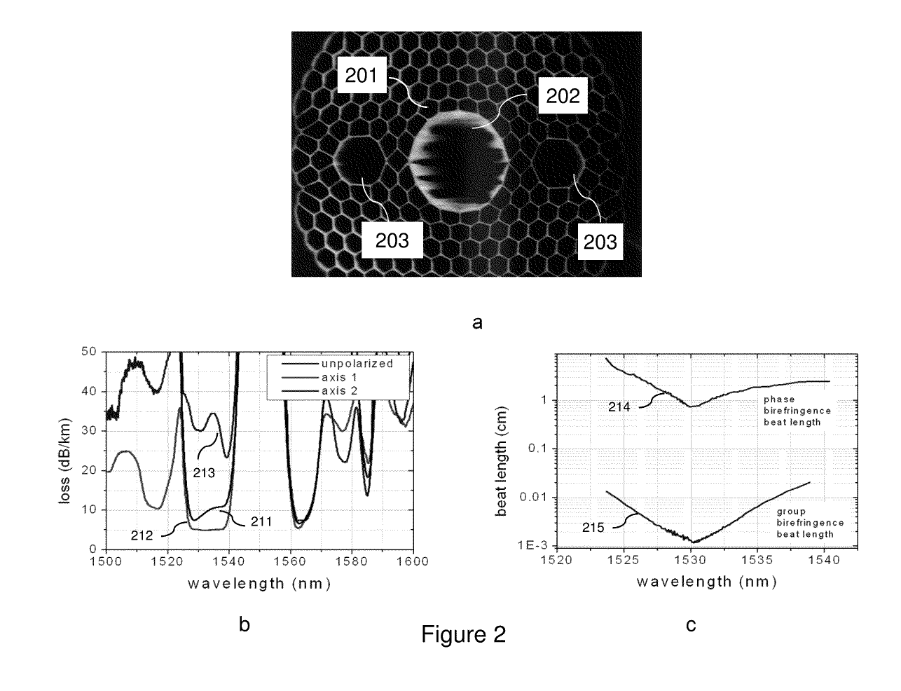

Referring now to FIG. 2, and more specifically to FIG. 2a, there it shows a scanning electron microscope (SEM) image of an experimental HCF constructed according to this invention. The fiber was produced using capillaries in a stack and-draw technique well known in the art (to be described in detail later). The HCF in this example has a 19-cell central hollow core (also core hereinafter) located approximately in the center of an inner cladding comprising a cellular matrix of holes. Two additional 7-cell hollow regions having a smaller diameter than the core extend throughout the length of the fiber along with the core (shunt core or shunt hereinafter) are positioned symmetrically about the core on either side. The shunt cores in general maintain roughly the same nominal size and position relative to the core throughout the length of the fiber.

The structure is qualitatively similar to that shown in FIG. 1 that is representative of a PRISM fiber as mentioned earlier in the context of the co-pending PCT application No. PCT/US/1335345 filed on Apr. 4, 2013, by Fini et al. This structure is selected for low loss transmission properties and in particular for the low-loss transmission of fundamental modes in the 19-cell core. While the illustration in FIG. 2a shows that the two additional shunts are roughly of the same shape and size, they need not be so. Other shapes, sizes and placement of additional shunt cores may be implemented governed by the desired characteristics of the HCF for a specific application.

Core and shunt asymmetry are selected such that at least for one wavelength of interest, they are compatible for simultaneous low loss operation in at least one signal mode of the core as well as high birefringence and suppression of at least one unwanted core mode such as a HOM. In some cases the structure may also provide polarization dependent loss while suppressing an unwanted polarization. Near single mode transmission properties of this exemplary HCF will be addressed in detail later. Excellent polarization control in this fiber is achieved by engineering of the surface modes localized at the web surrounding the core and the shunt cores through asymmetries introduced selectively in the inner cladding region.

For example, small asymmetry may be introduced selectively in the cellular web. The asymmetry may not be easily visible but it generates perturbation in the periodic nature of the web, particularly near the core-inner cladding boundary, which is sufficient to induce birefringence. For example, in this particular example of HCF, polarization dependence is produced by small variation in the thickness of the core wall web around the central core along its perimeter. The variation may originate from slightly thicker cell walls in some region of the inner cladding web (thick core web or thick web hereinafter) in at least one direction, and in particular near the core inner cladding interface, resulting in a slightly thicker core web along an axis perpendicular to the shunt core axis, for example, top and bottom of the core as shown in FIG. 2a. While the variation is difficult to see in the image shown in FIG. 2a, it is sufficient to generate significant birefringence as will be seen in FIGS. 2, 3, 4, 5 and 6 (to be described later).

In an exemplary HCF constructed according to the principles of this invention, the spacing of lattice holes in the cellular matrix is selected as L=5.0 μm with an air fill-fraction of about 95% in the silica web surrounding the central core (to match the band gap position). The central core has diameter 26.0 μm, slightly above the D_{core}˜5 L expected for a 19-cell core (the core spans 19 lattice cells). The diameter of each shunt is around 13.3 μm. The nominal core web thickness is estimated to be around 2.3 times the thickness of a lattice web, while the shunt webs are around 1.4 times that of a lattice web.

One important aspect of this invention is that polarization control is achieved by harnessing the surface modes that would have normally degraded the performance of hollow-core fibers. Surface modes are a central part of understanding HCF because they couple strongly with core modes at any wavelength where they are phase-matched. In prior art HCF much effort has been focused on eliminating these phase-matching points, since they generally lead to high loss and reduced bandwidth. However for a well-designed asymmetry, the surface modes may be made highly birefringent. In particular, the surface modes that are localized at the core web, very effectively sample the asymmetry in the core web. Core modes of the two different polarizations states experience phase-matched coupling at different wavelengths. This design aspect of controlling birefringence manifest in one polarization mode experiencing strong surface-mode coupling and therefore loss, while the other mode remains well guided at a signal wavelength of interest.

The measured loss shown in FIG. 2b illustrates this particular aspect for the above mentioned experimental HCF. The loss measured by cutback in a 500 m section of fiber is shown in FIG. 2b. The birefringence behavior is evident from the measured loss data. The un-polarized light represented by a trace 211 shows substantial loss throughout a band shorter than 1560 nm due to strong surface-mode features at 1535 nm and 1537 nm. However, when differentiated by polarization states, the loss is more significant in light polarized along one polarization (say axis 2) shown by a trace 212 at these wavelengths. On the other hand light launched along the other axis (say axis 1) shown by a trace 213 exhibits a window of low-loss (<10 dB/km) in a wavelength region 1526-1540 nm, with a minimum loss of 4.9±0.6 dB/km due to a narrow surface-mode peak at 1524 nm. Therefore, it is possible to design a HCF that would exhibit low polarization loss along at least one polarization axis at a wavelength of interest.

Measured phase birefringence and group birefringence are plotted as beat lengths in FIG. 2c. The phase birefringence beat length was measured, with a minimum below 6 mm. While the geometry is suggestive of the traditional stress-rod structure of the solid Polarization Maintaining (PM) fibers, remarkably, this low-loss HCF achieves beat length in the range of commercial PM fibers even though the usual mechanism (stress) is not available. The measured phase and group birefringence shown in traces 214 and 215, respectively, for the exemplary HCF structures shown in FIG. 2c also highlights significant nearly three orders of magnitude difference between phase and group birefringence.

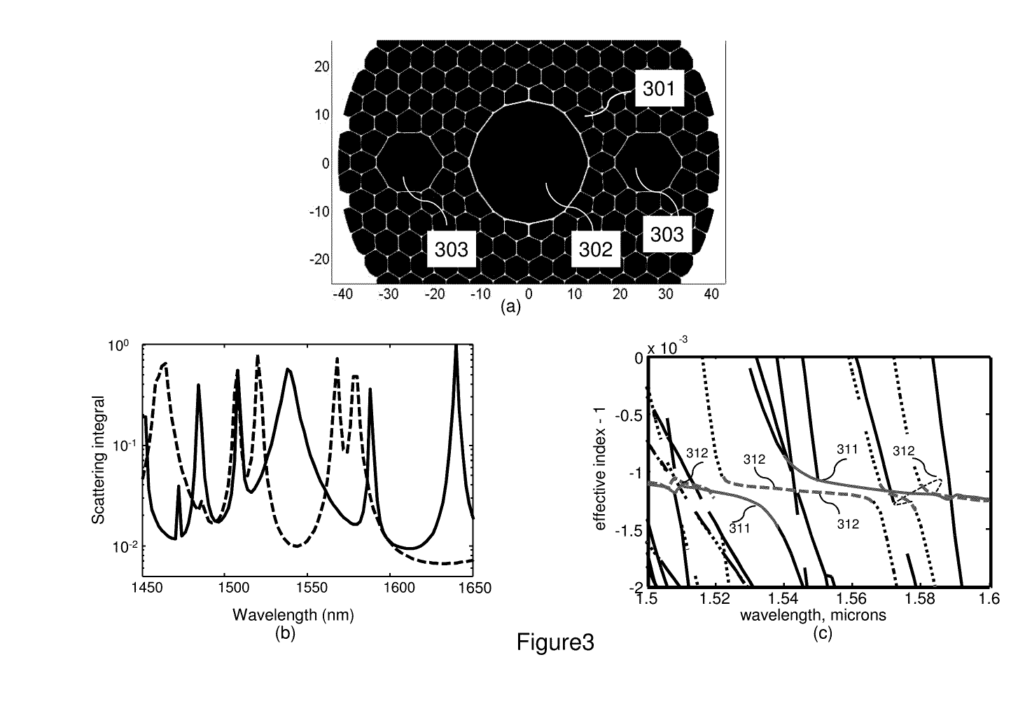

The mechanism of surface mode coupling in the HCF constructed according to this invention may be illustrated using simulations shown in FIG. 3. The simulations do not attempt to reproduce the detailed measurement results, since intrinsic sensitivity and limits of precisely fabricating or characterizing HCF geometry generally prohibit this. Instead, simulations focus on qualitative agreement using an idealized version of the experimental HCF shown in FIG. 1a, to better understand the underlying physics of the observed performance. Specific fiber geometries have been simulated to calculate birefringence and loss estimation in two orthogonal polarization modes. A fiber is simulated by arranging capillaries similar to an arrangement in a stack produced in a ‘stack and draw’ method. For example, a hollow core fiber is simulated by having, a) a core defined by several contiguous “missing” capillaries, and b) an inner cladding defined by a cellular lattice of capillaries having a nominal default capillary thickness, distributed around the core in a nominal regular lattice pattern. Numerical calculations were done with a 2d finite difference vector mode solver.

Geometrical parameters were determined from microscope images, but were also adjusted within the range of measurement uncertainties to fit optical measurements, for example the lattice air-fill-fraction for the simulation was set to 95.0% to match the bandgap position. To simulate a thicker core web according to this invention, the capillaries immediately surrounding the core are assigned a higher thickness as compared to the nominal default capillary thickness. Capillary thicknesses of a capillary ‘n’ are typically quantified by the “glass-fill-fraction” (GFF), defined as the ratio of inner diameter (D_{in,n}) to outer diameter (D_{out,n}) by GFFₙ=1−(D_{in,n}/D_{out,n})², whereas the glass fill fraction of the lattice capillaries is GFF₀. Specific preferred values of GFFₙ depend on all of the other geometric parameters of the fiber as well as the functionality to be incorporated in the HCF, such as birefringence, polarization dependent loss, etc.

More specifically, FIG. 3a is a schematic representation of an idealized HCF having a 19-cell central core and two 7-cell shunt cores positioned on either side of the central core. An inner cladding having lattice spacing, air fill-factor and slightly thicker core web along an axis perpendicular to the shunt cores near the core generates a distortion pattern of the inner cladding comparable to that of the experimental HCF shown in FIG. 1a. FIG. 3b shows surface scattering (proportional to loss) plotted as a function of wavelength for the two polarization states. A surface mode crossing at 1540 nm causes large scattering in one polarization state (solid trace) but not in the other polarization state (dashed trace). Notably, the surface scattering qualitatively exhibits similar trends as the measured loss shown in FIG. 2b where the low-loss high-PDL window at 1540 nm in the calculation corresponds to the 1535 nm window in the measured loss spectrum. FIGS. 2b and 3b also show that the polarization mechanism is different for different low-loss wavelength bands. For example, the window around 1565 nm in FIG. 2b corresponds to 1600 nm in FIG. 3b and shows low loss for both polarizations. Lack of polarization dependence in this window arises because the mechanism for polarization dependence is a resonant effect.

FIG. 3c shows effective index obtained from simulation plotted as a function of wavelength. Surface modes are shown in black (solid trace), except for those of the same symmetry class as the low-loss signal mode shown in black (dotted trace) which have no crossing near phase-matching point 1.54 μm (1540 nm). As wavelength is varied past the phase-matching point 1.54 μm (1540 nm) the core mode corresponding to high-loss polarization state shown as 311 (blue trace) continuously transforms into a surface mode (black solid trace) with a clear anti-crossing behavior characteristic of resonant coupling. It is noted that the high-loss polarization state shown as 311 (blue trace) is pulled away from that of the low-loss polarization state shown as 312 (red trace). Interaction with the surface modes thus produces large calculated birefringence Δn_{eff}˜3×10⁻⁴ (beat length ˜5 mm). Interestingly, while the plot shows several surface mode crossings with various degrees of polarization dependence, only one of them exhibits large birefringence.

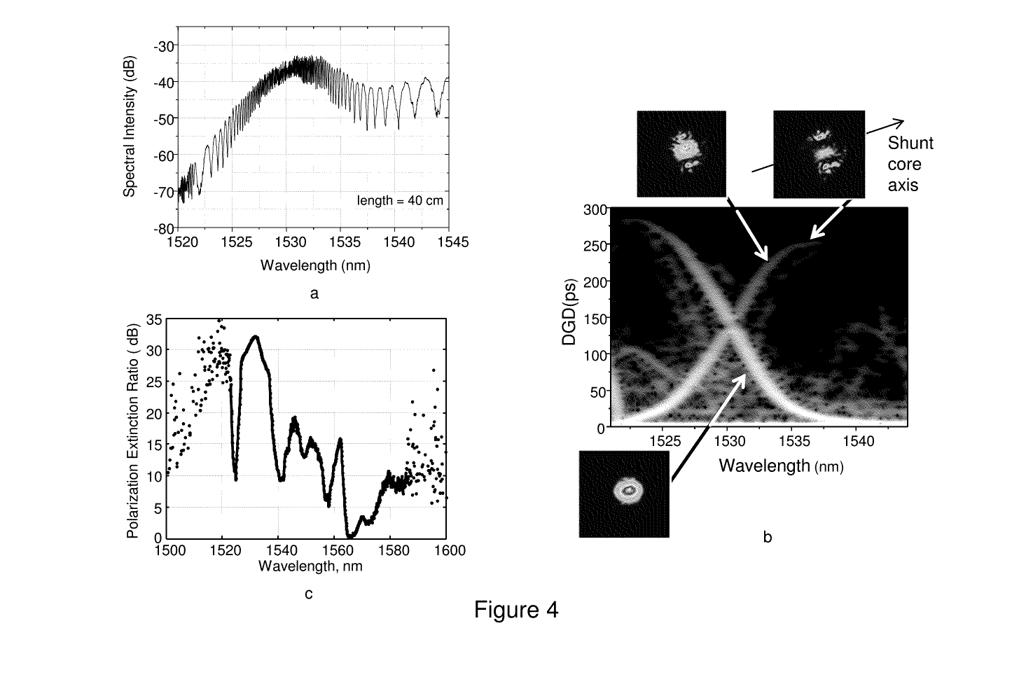

Referring now to FIG. 4, measurements of group birefringence were obtained from spectral interference of the form shown in FIG. 4a. Bulk optic polarizers at the input and output of the fiber were aligned to maximize the observed spectral interference. The output beam was focused onto a single mode fiber that was coupled to an optical spectrum analyzer with 0.01 nm resolution bandwidth. Phase birefringence measurements were obtained by cutting back the length of the fiber under test in small increments and measuring the group birefringence beating as a function of the length. As the fiber was cut-back, the power at any given wavelength oscillated between maxima and minima. The phase birefringence beat length at that wavelength was the length of the fiber to go from one minimum to the next. Cutbacks as short as 0.5 mm in length were performed to ensure that the cutback length was much shorter than the minimum phase birefringence beat length.

Interference as a function of wavelength is plotted in FIG. 4a when both polarizations are excited. The low-loss polarization interferes with a modal mixture: the high-loss polarization is coupled to a surface mode. The group birefringence (shown in FIG. 2c), or equivalently a differential group delay may be estimated from beating between polarizations plotted as function of wavelength, shown in the plot in FIG. 4a. The beating of polarization indicates birefringence in the experimental HCF. The images of the higher-order modes in the PM (Polarization Mode) spectrogram of FIG. 4b were obtained using S² imaging which is based on coherent interference of multiple modes co-propagating in the HCF. Light from a narrow linewidth tunable laser was launched into the fiber under test using bulk-optic coupling. The output of the HCF was flat cleaved and the beam launched into free-space. Input and output polarizers were aligned to maximize the spectral interference due to polarization beating, such as that observed in FIG. 2a. The beam was imaged onto an InGaAs camera sensitive at 1550 nm. The beam profile of the fiber under test was obtained as the wavelength of the narrow linewidth laser was tuned. Higher-order mode images and relative power levels were obtained via the data analysis described in.

The sliding Fourier window calculation of higher-order mode spectrograms is based on measuring interference between coherent modes that propagate with different group delays in the fiber under test. The input and output ends of 5m lengths of hollow-core fibers were fusion spliced to standard single-mode fiber. The fusion splice was made as short and cold as possible to prevent the collapse of holes in the HCF. Note that because there are two SMF-HCF splices in the experiment, with each splice acting as a mode transformer, the mode content transmitted through the system is approximately half the mode content propagating in the HCF. A narrow linewidth (few hundred kHz) tunable laser was launched into the fiber under test, and the transmission was measured with a power meter. The frequency of the laser was tuned through the wavelength range of interest. The maximum tuning range of the laser was 1500 nm to 1610 nm, and the step size was 0.003 nm.

A small subset of the transmission data with a width of approximately 3 nm was selected with a narrow window and Fourier-transformed. The window is then slid through the entire transmission spectrum. Data analysis relating Fourier transform amplitude to mode amplitude was then applied to produce a plot of mode content vs. wavelength and group delay. Because the modes are co-propagating, the modes are measured as a function of differential group delay, or difference in group delay between the fundamental mode and the higher order modes. Differential Group Delay (DGD) plotted as a function of wavelength from spectrogram analysis is shown in FIG. 4b.

The plot in FIG. 4b illustrates multiple beat notes: a “slow” beating between the two core modes (e.g., 25 ps delay over 40 cm fiber length at 1525 nm), and a much faster beating between a core mode and another (surface) mode (e.g., 275 ps delay at 1525 nm). As the resonant wavelength is passed, the high-loss core mode continuously transforms into the surface mode and vice-versa. Beating with the low-loss polarization, shown by the two traces in the sliding window Fourier Transform plot in FIG. 4b, likewise takes the form of a continuous transformation: the fast and slow beating become less distinct and eventually cross at the wavelength of highest polarization-dependent loss. Clear evidence of an anti-crossing around 1530 nm is exhibited in the measured interference between the two polarizations.

The mode images of beat notes confirm a transition of core mode to surface mode as wavelength is varied across the phase-matched resonance. The high birefringence and polarization dependent loss in the experimental HCF enable transmission of signal with a well-controlled polarization state over a reasonably long length of the HCF. The measured PER (Polarization Extinction Ratio) as a function of wavelength is plotted in FIG. 4c. The fiber allows a signal to be transmitted in a preferred dominant polarization state over long lengths. For example, in the experimental HCF a 32 dB extinction ratio is measured after 467 m of fiber at 1532 nm. The measured PER exceeds the specification required for many PM fiber applications.

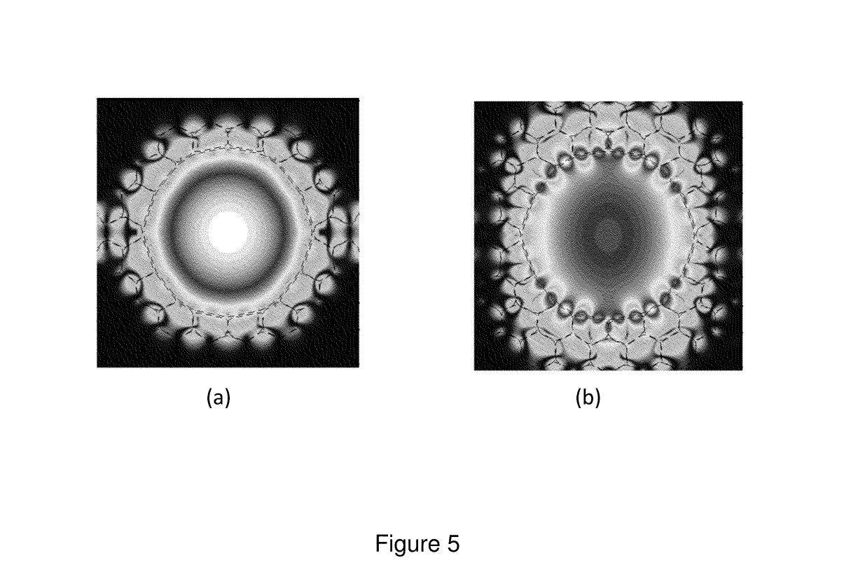

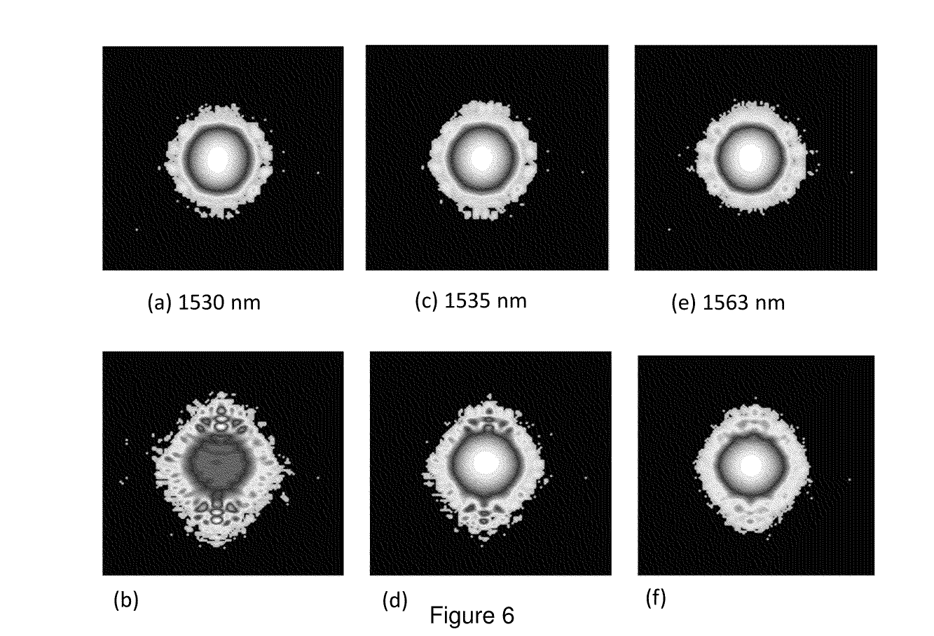

Engineering the core web asymmetry produces localized surface modes and thus enables control of the birefringence resulting from surface mode coupling. More specifically, the core web asymmetry is introduced by thick core web localized near the top and bottom of the core in this example. Simulated mode field intensity is plotted on a log-scale for the calculated modes in FIGS. 5(a) and 5(b) for the low-loss (a) and high-loss (b) polarizations, respectively. Strong components localized at the thick webs (top and bottom of the core) at the wavelength of highest PDL, is evident. Measured near-field images for the experimental HCF are shown in FIG. 6 (a-f) for three wavelengths (1530, 1535 and 1563 nm) and two polarizations shown in FIGS. 5a and 5b. Images for polarization aligned with the shunt core axis are shown in images a, c, and e for the three wavelengths, while images for polarization aligned across the shunt core axis are shown in images b, d and f.

The mode field intensity patterns for the simulated HCF (FIG. 5) and the experimental HCF (FIG. 6) for low-loss and high-loss conditions are remarkably similar to the measured patterns at 1530 nm shown in FIGS. 6a and 6b, respectively. The remarkable similarity confirms that the polarization-dependence achieved is a direct result of the controlled asymmetry designed into the structure. Images of the high-loss polarization (FIGS. 6b, and 6d) at high-PDL wavelengths shows bright spots at the location where core webs are thicker, while the low-loss polarization (FIGS. 6a and 6c) shows essentially no intensity in this region. As expected, this effect is much less pronounced at 1563 nm (FIGS. 6e and 6f), where polarization-dependent loss is low (see FIG. 4c).

### Single-Modedness

It is known that alternative paths to effectively suppress polarization dependent loss and Higher Order Modes (HOMs) in hollow core fibers may be provided via additional shunt cores similar to those described in the U.S. Pat. No. 7,865,051 issued on Jan. 4, 2011, and U.S. Pat. No. 7,356,233 issued on Apr. 8, 2009, respectively, both to Fini. More specifically, unwanted core modes including HOMs, may be effectively suppressed by allowing unwanted modes to selectively couple to shunt modes in a shunt core fiber as has been described in the co-pending, and co-owned application No. PCT/US13/35345 filed on filed Apr. 4, 2013, by Fini.

Shunt core fiber is basically a hollow core fiber where additional hollow region(s) (shunt cores preferably having smaller diameter than the central core) are located near the core. The additional hollow region(s) provides paths for unwanted modes to leak to the cladding. However, the loss mechanism in that fiber may or may not be polarization sensitive. One variation of shunt core fiber is a PRISM fiber described in the above mentioned co-pending parent PCT application by Fini et al. There it is described that a PRISM fiber could simultaneously achieve lower loss and much better single-modedness than any 7-cell fiber, thus breaking the tradeoff between loss and modal control. However, the actual loss reported (7.5 dB/km at 1590 nm) was still significantly higher than the record for larger-core HCF (1.2 dB/km in a 19-cell core).

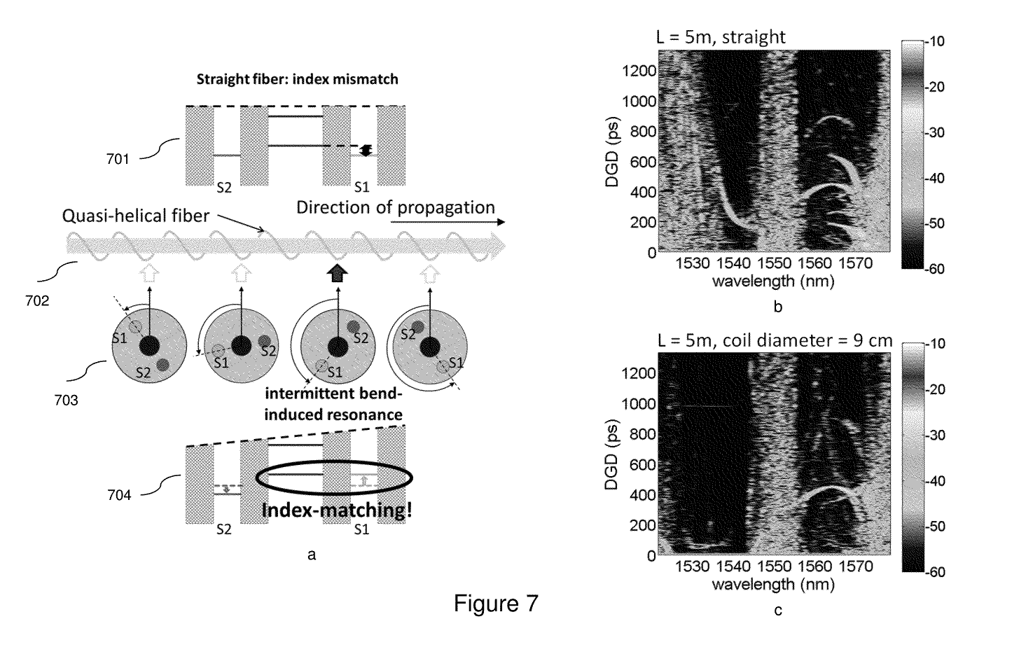

Currently, the PRISM fiber provides the best adaptation of a robust resonantly-coupled fiber design, which does not require that the fabricated fiber geometry provide perfectly resonant coupling of all unwanted core modes as has been described in detail in the co-pending parent PCT application No. PCT/US/1335345 filed on Apr. 4, 2013, by Fini et al. More specifically, small index mismatches between a higher-order core mode and shunt modes are intermittently cancelled by the bend-induced index tilt, as long as the fiber is bent sufficiently and the orientation of the fiber with respect to the bend is allowed to drift, as shown schematically in FIG. 7. In particular, in FIG. 7a, section 701 depicts small index mismatches between a higher order core mode and shunt modes that may arise due to non-uniformity in the fiber naturally introduced during the fiber drawing process, despite exercising all practical measures in manufacturing control. However, the mismatch is finite and may cause some HOMs and particularly HOMs having low loss to still propagate in the core.

Bending or coiling the fiber gently in a helical fashion, for example, as depicted in section 702 introduces an index tilt that continuously varies as the coiling orientation drifts as shown in section 703. The continuously varying index tilt in PRISM fiber is extremely beneficial because this periodically cancels the index mismatch resulting in intermittent index matching. The bend radius induced index tilt compensates for the index mismatch thereby allowing higher order core modes to experience intermittent phase-matched resonance coupling with shunt modes. One such phase matching resonance coupling point is shown by the bold dark upward arrow in section 703 along with the index matching condition shown within an ellipse in section 704. While intermittent phase-matched resonance coupling occurs at several points along the length of the fiber (but not at all points) only over a fraction of the total fiber length, it is sufficient to suppress HOMs and achieve nearly single-moded operation (effective single mode transmission).

The basic structure of the HCF designed according to this invention (shown in FIG. 2a) is substantially similar to the PRISM fiber described in the above mentioned co-pending parent PCT application No. PCT/US/1335345 filed on Apr. 4, 2013, by Fini et al. More specifically, the experimental HCF comprising a 19-cell core and two 7-cell shunt cores are substantially similar in shape and dimension to respective, core and shunt cores of the PRISM fiber. The fundamental modes in a low-loss 19-cell HCF are very well confined to the core, and see very little beyond the first layer of cladding holes. The 7-cell shunt cores selectively suppress higher-order modes of the core but are not very effective in generating strong birefringence or polarization dependent loss.

In one preferred embodiment of HCF according to this invention, the polarization controlling aspects for selective suppression of a polarization mode described in the previous section is applied to a PRISM fiber designed for suppression of higher order modes (HOM). More specifically, excellent polarization selective loss suppression properties are incorporated by carefully controlling the asymmetry of glass web around the core of a PRISM fiber designed to exhibit a low loss near single-moded operation. Resulting experimental HCF according to this invention (shown in FIG. 2a) achieves birefringence, low PDL (Polarization Dependent Loss), low loss (optical) and near single mode operation despite fundamental limitations and tradeoffs observed in achieving similar performance in other prior art HCF, including those described in the above mentioned co-owned patents and patent applications (PCT/US/1335345 filed on Apr. 4, 2013, by Fini et al., PCT/US/1332652, filed on Mar. 15, 2013, by DiGiovanni et al., and the co-owned U.S. Pat. No. 7,865,051 issued on Jan. 4, 2011, U.S. Pat. No. 7,356,233 issued on Apr. 8, 2009, respectively, both to Fini)

The results obtained on the experimental HCF according to this invention reflects better performance over the prior art HCF. The experimental HCF substantially similar to a PRISM fiber, but including polarization control introduced by applying asymmetry in the core web structure according to this invention, exhibits loss below 5 dB/km in a single-mode operation, even while meeting the conflicting challenge of operating in a high PDL regime (which comes with an additional and significant loss mechanism of polarization cross-coupling). Mode content for said experimental HCF is quantified by analyzing modal interference patterns which can be plotted as a function of wavelength and delay in the sliding-Fourier maps. There is substantial interference with unwanted mode in the wavelength range of interest when the fiber is straight, but this mode content is greatly reduced when the fiber is coiled in a bend radius of 9 cm diameter or tighter. FIGS. 7b and 7c respectively, show measured modal interference over comparable length of a straight section and a coiled section of the experimental HCF. At about 1530 nm the straight section (7b) shows moderate HOM content but it is drastically reduced when the fiber is coiled to about 9 cm diameter (7c), or lower.

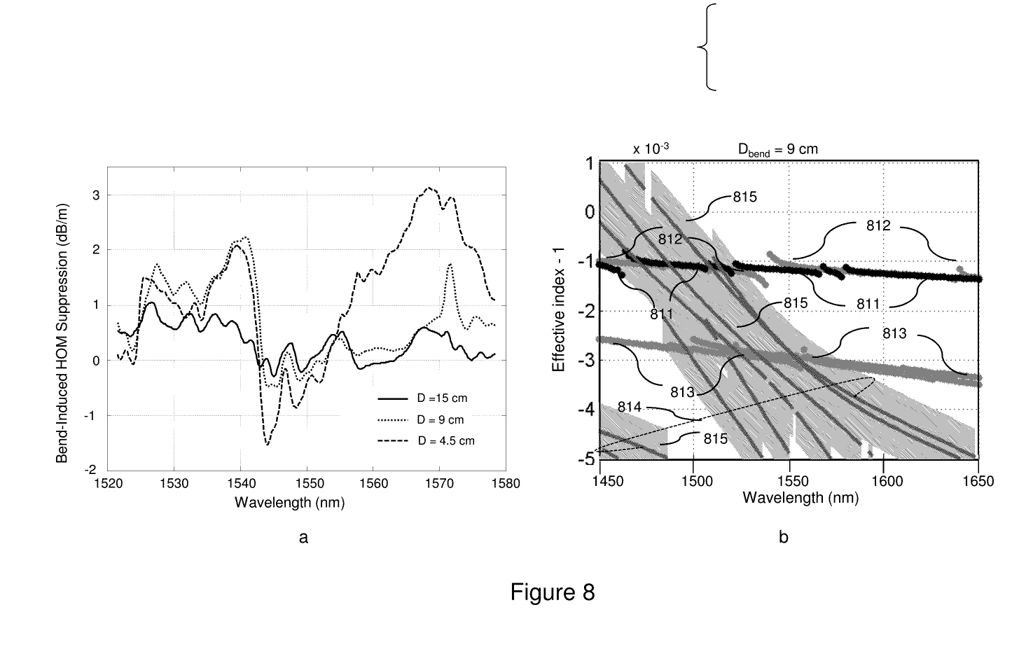

Experimentally measured variations in bend induced mode suppression are analyzed to further quantify HOM suppression. FIG. 8 shows some results obtained from these measurements. More specifically, bend-induced mode suppression (y-axis) as a function of wavelength (x-axis) is plotted for the experimental HCF coiled at different bend diameters (4.5, 9.0 and 15.0 cm, respectively). The HOM suppression is moderately effective for a bend diameter of 15 cm (solid line) whereas significant reduction in modal interference is observed when the HCF is coiled at a bend diameter of 9 cm (dotted line) or lower 4.5 cm (dashed line), respectively. From these measurements HOM suppression >1 dB/m is estimated.

The experimental observations are further substantiated by calculations performed on a simulated fiber of comparable physical structure, dimension and properties, as has been earlier described in reference with FIG. 3. More specifically, effective index for a straight section of HCF is calculated as a function of wavelength and plotted in FIG. 8b. The fundamental modes for the two polarizations are shown in traces 811 (black) and 812 (upper grey bold) stretching across the graph from left to right. LP11-like modes are shown in trace 813 (lower bold grey) also stretching across the graph from left to right, whereas shunt modes are shown collectively as solid grey thinner traces 814 (running from top to bottom of the graph), respectively. It is clear that index mismatch between the LP11-like modes (813) and the shunt modes in a wavelength of interest (1500 nm-1650 nm) is significant. However, the same calculations repeated for a fiber coiled in a diameter of about 9 cm show significant spread in the effective index (light grey shaded regions 815 in FIG. 8b). The effective index of shunt modes (814) are now spread into the grey shaded regions 815 due to bend-induced perturbation thereby, allowing the LP11-like modes (813) to sufficiently overlap with, and effectively couple to the shunt modes over the wavelength of interest.

### Preferred Construction

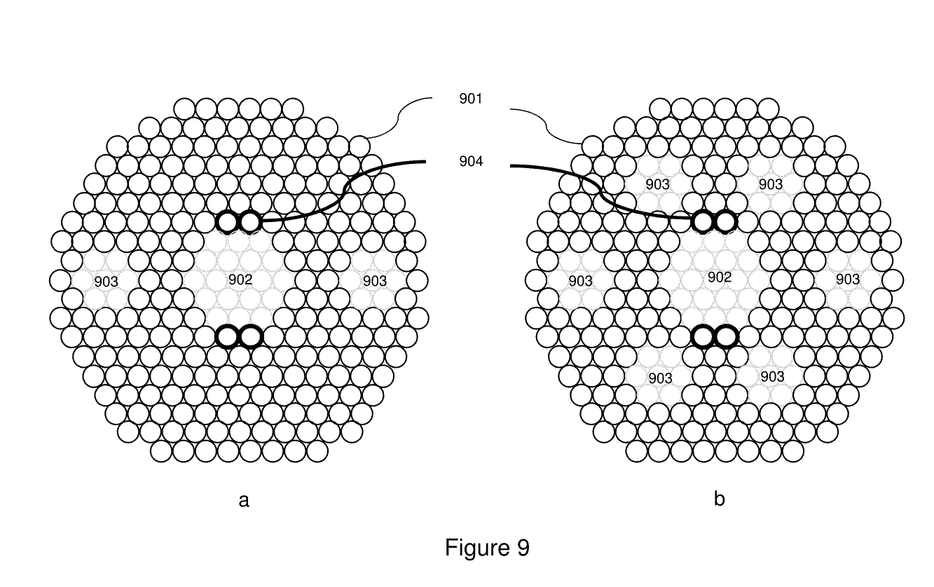

As mentioned earlier, birefringence of the core modes is controlled through the local asymmetry introduced in the fiber structure around the core. In this context, asymmetry means having no symmetry under rotations of less than ‘pi’ radians-for example, an ellipse in this context is asymmetric even though it has two axes of reflection symmetry. The exemplary HCF described may be constructed using a stack-and-draw assembly of capillaries and tubes. FIG. 9 schematically shows a two-dimensional cross section of capillary arrangements (cut perpendicular to the length of the fiber). Two different arrangements shown in FIGS. 9a and 9b are only illustrative of the fact that the number and placement of shunt cores can differ to achieve a required birefringence and near single-mode operation suitable for a given application. While the description in the previous sections is always in reference with only two shunts, it is not a limiting condition to practice the invention. The example of two shunts is selected for explaining the concepts more clearly.

The stack comprise of capillaries 901 (only one labeled for clarity) that have substantially similar nominal diameter and wall thickness such that a nominally uniform cellular lattice structure (or a uniform web) having nominal uniform lattice spacing is achieved. The majority of the inner cladding comprises a uniform web. The diameter and wall thickness is selected to achieve a desired air-fill factor as well as an optical band gap for guiding a particular signal mode having a desired polarization state at a pre-determined wavelength in a central core 902 which is a contiguous region where a pre-determined number of capillaries are removed (shown as faint circles) thereby, generating a hollow core region of a desired shape and size in the stack. The local core geometry may be determined to define an axis of birefringence. More conventionally, the core is placed at the nominal center of the fiber.

Mode control is implemented by selectively suppressing at least one unwanted core mode by coupling the selected mode into one or more shunt cores. One or more shunt cores 903 may similarly be created by removing a predetermined number of capillaries (shown as faint circles) from the stack at pre-determined locations relative to the core. In the particular design shown in FIG. 9a, the core and shunts fall along a horizontal ‘shunt’ axis. It is preferred that the pattern of shunts (whether one or more) have a symmetry axis that coincides with an axis of reflection symmetry for the local core geometry. Core and shunt asymmetry are implemented such that for at least one wavelength of interest, they are compatible to achieve simultaneous low-loss operation in at least one signal mode of the core as well as high birefringence while suppressing at least one unwanted mode. In some carefully designed HCF, the structure may also provide polarization dependent loss suppressing an unwanted polarization state.

One important aspect of the invention is engineering of the surface modes localized at the web surrounding the core and the shunt. In this particular example the surface modes are manipulated by introducing capillaries 904 shown as thick circles (only one labeled for clarity) that are slightly different from the other capillaries comprising the uniform web (defect capillaries hereinafter to distinguish them from the uniform web capillaries). The schematic specifically shows a set of four capillaries that are located adjacent to the core, farthest from the shunt axis and touch the axis perpendicular to the core. The pattern of defect capillaries is preferably selected such that an axis of core birefringence is defined and to have reflection symmetry across the shunt axis such that the birefringence axis preferably coincides with the shunt axis in this particular design. In a specific design, the defect capillaries may be selected to have a solid cross-section area substantially different than the rest of the uniform web capillaries (901) comprising the majority of the cellular structure; in particular, the defect capillaries have a cross-section area about 1.6 times that of the rest of the capillaries.

It is possible to construct a HCF using a single shunt. However, it is preferred that the arrangement of shunts have a symmetry axis that coincides with an axis of reflection symmetry for the local core geometry (e.g. an axis of reflection symmetry for the defect pattern) such that the pattern of shunts does not introduce polarization coupling or introduces variation in the birefringent axis (with wavelength, fiber length etc.). While the local core geometry defines an axis of birefringence, it need not depend on a pattern of defects to achieve so. Other methods to generate core asymmetry may use a core tube with thickness that varies azimuthally to create a core web that is thicker along certain pre-determined directions, for example.

While principles and methods of the invention is explained using a few representative embodiments and specific examples, other arrangements of defect cells, shape, size and placement of core and shunt cores, may be applied to practice the invention to achieve a desired level of birefringence, polarization suppression, and near single mode transmission of particular signal modes in the hollow core. All other combinations and sub-combinations that may be apparent to those skilled in the art are covered by the claims that follow.

What is claimed is:

1. An optical fiber comprising:
a hollow core;
an inner cladding comprising a cellular matrix surrounding the hollow core, said inner cladding including a plurality of cells having holes, wherein adjacent holes are connected by cell walls of a nominal uniform thickness resulting in a uniform web, said plurality of cells arranged in a lattice pattern, said plurality of cells further including a pre-determined number of different cells located proximal to the hollow core preferably at the interface with the inner cladding to provide a desired asymmetry in the uniform web along a pre-determined axis, thereby inducing birefringence along the pre-determined axis; and
one or more hollow shunt cores, positioned in the inner cladding at a pre-determined distance from the hollow core to couple unwanted modes from the hollow core, such that the hollow shunt core suppresses transmission of unwanted modes including one or more HOMs, thereby facilitating transmission of at least one desired mode at a pre-determined polarization state in the hollow core.

2. The optical fiber as in claim 1, wherein one or more shunt cores are disposed along a symmetry axis that coincides with an axis of reflection symmetry of the hollow core geometry.

3. The optical fiber as in claim 1, wherein the hollow core and one or more shunt cores are disposed preferably along a common geometric axis passing through the hollow and one or more shunt cores.

4. The optical fiber as in claim 3 including two shunt cores positioned symmetrically on either side of the hollow core such that the common geometric axis is perpendicular to the length axis of the fiber.

5. The optical fiber as in claim 1, wherein the one or more shunt cores are designed to selectively suppress one polarization state and support transmission of the orthogonal polarization state of the at least one desired mode.

6. The optical fiber as in claim 1, wherein the asymmetry in the uniform web proximal to the hollow core extends preferably up to one to two cells of the cellular matrix at the interface of the hollow core with the inner cladding.

7. The optical fiber as in claim 1, wherein the cell wall thickness of said different cells is more than the nominal cell wall thickness of the cells in the uniform web, such that the web proximal to the hollow core at the interface with the inner cladding is thicker along an axis perpendicular to the length axis of the fiber.

8. The optical fiber as in claim 1 disposed in a coil having a nominally uniform bend diameter such that the coupling of unwanted modes from the hollow core to the one or more shunt core is effected through intermittent bend-induced resonant index matching to induce a Perturbed Resonance for Improved Single Modedness (PRISM) in the optical fiber.

9. An optical fiber comprising:
a hollow core;
an inner cladding comprising a cellular matrix surrounding the hollow core, said inner cladding including a plurality of cells having holes, wherein adjacent holes are connected by cell walls of a nominal uniform thickness resulting in a uniform web, said plurality of cells arranged in a lattice pattern, said plurality of cells further including a pre-determined number of different cells located proximal to the hollow core preferably at the interface with the inner cladding to provide a desired asymmetry in the uniform web along a pre-determined axis, thereby inducing birefringence along the pre-determined axis; and
two identical hollow shunt cores having diameters smaller than the diameter of the hollow core, said hollow shunt cores positioned symmetrically in the inner cladding on either side of the hollow core at a pre-determined distance from the hollow core, wherein a common symmetry axis passing through the hollow and the two hollow shunt cores is perpendicular to the length axis of the fiber, and the common symmetry axis coincides with an axis of reflection symmetry for the hollow core geometry, such that hollow shunt cores couple unwanted modes from the hollow core so as to suppress transmission of unwanted modes including one or more HOMs, and facilitating transmission of at least one desired mode at a pre-determined polarization state in the hollow core.

10. The optical fiber as in claim 9, wherein the asymmetry in the uniform web proximal to the hollow core extends preferably up to one to two cells of the cellular matrix at the interface of the hollow core with the inner cladding.

11. The optical fiber as in claim 9, wherein the cell wall thickness of said different cells is more than the nominal cell wall thickness of the cells in the uniform web, such that the web proximal to the hollow core at the interface with the inner cladding is thicker along an axis perpendicular to the length axis of the fiber.

12. The optical fiber as in claim 9 disposed in a coil having a nominally uniform bend diameter such that the coupling of unwanted modes from the hollow core to the two hollow shunt cores is effected through intermittent bend-induced resonant index matching to induce a Perturbed Resonance for Improved Single Modedness (PRISM) in the optical fiber.

13. An optical fiber comprising:
a hollow core;
an inner cladding comprising a cellular matrix surrounding the hollow core, said inner cladding including a plurality of cells having holes, wherein adjacent holes are connected by cell walls of a nominal uniform thickness resulting in a uniform web, said plurality of cells arranged in a lattice pattern, said plurality of cells further including a pre-determined number of different cells located proximal to the hollow core preferably at the interface with the inner cladding to provide a desired asymmetry in the uniform web along a pre-determined axis, thereby inducing birefringence along the pre-determined axis.

14. The optical fiber as in claim 13, wherein the asymmetry in the uniform web proximal to the hollow core extends preferably up to one to two cells of the cellular matrix at the interface of the hollow core with the inner cladding.

15. The optical fiber as in claim 9, wherein the cell wall thickness of said different cells is more than the nominal cell wall thickness of the cells in the uniform web, such that the web proximal to the hollow core at the interface with the inner cladding is thicker along an axis perpendicular to the length axis of the fiber.
